(19) United States
(12) Patent Application Publication
(10) Pub. No.: US 2024/0176842 A1
(43) Pub. Date: May 30, 2024

(54) SYSTEMS AND METHODS FOR INCREASING DIVERSITY OF SAMPLES

(71) Applicant: D-WAVE SYSTEMS INC., Burnaby (CA)

(72) Inventor: Alex Zucca, Coquitlam (CA)

(21) Appl. No.: 18/142,374

(22) Filed: May 2, 2023

Related U.S. Application Data
(60) Provisional application No. 63/339,602, filed on May 9, 2022.

(51) Int. Cl. G06F 17/11

(52) U.S. Cl. CPC G06F 17/11

(57) ABSTRACT

Systems and methods for operating a computer system to generate samples having improved diversity are discussed. A processor receives a problem definition with a problem Hamiltonian defined over a set of variables and samples one or more values for the set of variables from the problem Hamiltonian, the one or more values for the set of variables comprising a first set of samples. At least a subset of the first set of samples is selected, and a diversity Hamiltonian based on the at least a subset of the first set of samples is generated. The problem Hamiltonian and the diversity Hamiltonian are combined to generate a combined Hamiltonian, and one or more values for the set of variables are sampled from the combined Hamiltonian, the one or more values for the set of variables comprising a second set of samples.

### FIELD

This disclosure generally relates to systems and methods for increasing the diversity of samples returned by a sampler, for instance in a hybrid computer combining digital processors and analog processors.

### BACKGROUND

### Quantum Devices

Quantum devices are structures in which quantum mechanical effects are observable. Quantum devices include circuits in which current transport is dominated by quantum mechanical effects. Such devices include spintronics and superconducting circuits. Both spin and superconductivity are quantum mechanical phenomena. Quantum devices can be used for measurement instruments, in computing machinery, and the like.

### Quantum Computation

A quantum computer is a system that makes direct use of at least one quantum-mechanical phenomenon, such as superposition, tunneling, and entanglement, to perform operations on data. The elements of a quantum computer are qubits. Quantum computers can provide speedup for certain classes of computational problems such as computational problems simulating quantum physics.

### Quantum Processor

A quantum processor may take the form of a superconducting quantum processor. A superconducting quantum processor may include a number of superconducting qubits and associated local bias devices. A superconducting quantum processor may also include coupling devices (also known as couplers or qubit couplers) that selectively provide communicative coupling between qubits.

A quantum processor is any computer processor that is designed to leverage at least one quantum mechanical phenomenon (such as superposition, entanglement, tunneling, etc.) in the processing of quantum information. Regardless of the specific hardware implementation, all quantum processors encode and manipulate quantum information in quantum mechanical objects or devices called quantum bits, or “qubits;” all quantum processors employ structures or devices to communicate information between qubits; and all quantum processors employ structures or devices to read out a state of at least one qubit. A quantum processor may include a large number (e.g., hundreds, thousands, millions, etc.) of programmable elements, including but not limited to: qubits, couplers, readout devices, latching devices (e.g., quantum flux parametron latching circuits), shift registers, digital-to-analog converters, and/or demultiplexer trees, as well as programmable sub-components of these elements such as programmable sub-components for correcting device variations (e.g., inductance tuners, capacitance tuners, etc.), programmable sub-components for compensating unwanted signal drift, and so on.

Further details and embodiments of example quantum processors that may be used in conjunction with the present systems and devices are described in, for example, U.S. Pat. Nos. 7,533,068; 8,008,942; 8,195,596; 8,190,548; and 8,421,053.

### Hybrid Computing System Comprising a Quantum Processor

A hybrid computing system can include a digital computer communicatively coupled to an analog computer. In some implementations, the analog computer is a quantum computer, and the digital computer is a classical computer.

The digital computer can include a digital processor that can be used to perform classical digital processing tasks described in the present systems and methods. The digital computer can include at least one system memory which can be used to store various sets of computer- or processor-readable instructions, application programs and/or data.

The quantum computer can include a quantum processor that includes programmable elements such as qubits, couplers, and other devices. The qubits can be read out via a readout system, and the results communicated to the digital computer. The qubits and the couplers can be controlled by a qubit control system and a coupler control system, respectively. In some implementations, the qubit and the coupler control systems can be used to implement quantum annealing on the analog computer.

### Quantum Annealing

Quantum annealing is a computational method that may be used to find a low-energy state of a system, typically preferably the ground state of the system. The method relies on the underlying principle that natural systems tend towards lower energy states, as lower energy states are more stable. Quantum annealing may use quantum effects, such as quantum tunneling, as a source of delocalization to reach an energy minimum.

A quantum processor may be designed to perform quantum annealing and/or adiabatic quantum computation. An evolution Hamiltonian can be constructed that is proportional to the sum of a first term proportional to a problem Hamiltonian and a second term proportional to a delocalization Hamiltonian, as follows:

H_{E}∝A(t)H_{P}+B(t)H_{D}

where H_{E} is the evolution Hamiltonian, H_{P} is the problem Hamiltonian, H_{D}is the delocalization Hamiltonian, and A(t), B(t) are coefficients that can control the rate of evolution, and typically lie in the range [0,1].

In some implementations, a time varying envelope function can be placed on the problem Hamiltonian. A suitable delocalization Hamiltonian is given by:

$${H}_{D} ∝ - \frac{1}{2} {\sum }_{i = 1}^{N} {Δ}_{i} {σ}_{i}^{x}$$

where N represents the number of qubits, σᵢ^{x} is the Pauli x-matrix for the i^{th} qubit and Δᵢ is the single qubit tunnel splitting induced in the i^{th} qubit. Here, the σᵢ^{x} terms are examples of “off-diagonal” terms.

A common problem Hamiltonian includes a first component proportional to diagonal single qubit terms and a second component proportional to diagonal multi-qubit terms, and may be of the following form:

$${H}_{P} ∝ - \frac{ε}{2} [ {\sum }_{i = 1}^{N} {h}_{i} {σ}_{i}^{z} + {\sum }_{j > i}^{N} {J}_{ij} {σ}_{i}^{z} {σ}_{j}^{z} ]$$

where N represents the number of qubits, af is the Pauli z-matrix for the i^{th} qubit, hᵢ and Jᵢⱼ are dimensionless local fields for the qubits, and couplings between qubits, and F is some characteristic energy scale for H_{P}.

Here, the σᵢ^{z} and σᵢ^{z}σⱼ^{z} of terms are examples of “diagonal” terms. The former is a single qubit term and the latter a two-qubit term.

Throughout this specification, the terms “problem Hamiltonian” and “final Hamiltonian” are used interchangeably unless the context dictates otherwise. Certain states of the quantum processor are energetically preferred, or simply preferred, by the problem Hamiltonian. These include the ground states but may include excited states.

Hamiltonians such as H_{D} and H_{P} in the above two equations, respectively, may be physically realized in a variety of different ways. A particular example is realized by an implementation of superconducting qubits.

### Sampling

Throughout this specification and the appended claims, the terms “sample”, “sampling”, “sampling device”, and “sample generator” are used.

In statistics, a sample is a subset of a population, i.e., a selection of data taken from a statistical population. In electrical engineering and related disciplines, sampling relates to taking a set of measurements of an analog signal or some other physical system.

In many fields, including simulations of physical systems, and computing, especially analog computing, the foregoing meanings may merge. For example, a hybrid computer can draw samples from an analog computer. The analog computer, as a provider of samples, is an example of a sample generator. The analog computer can be operated to provide samples from a selected probability distribution, the probability distribution assigning a respective probability of being sampled to each data point in the population. The population can correspond to all possible states of the processor, and each sample can correspond to a respective state of the processor.

### Markov Chain Monte Carlo

Markov Chain Monte Carlo (MCMC) is a class of computational techniques which include, for example, simulated annealing, parallel tempering, population annealing, and other techniques. A Markov chain may be used, for example when a probability distribution cannot be used. A Markov chain may be described as a sequence of discrete random variables, and/or as a random process where at each time increment the state only depends on the previous state. When the chain is long enough, aggregate properties of the chain, such as the mean, can match aggregate properties of a target distribution.

The Markov chain can be obtained by proposing a new point according to a Markovian proposal process (generally referred to as an “update operation”). The new point is either accepted or rejected. If the new point is rejected, a new proposal is made, and so on. New points that are accepted are ones that make for a probabilistic convergence to the target distribution. Convergence is guaranteed if the proposal and acceptance criteria satisfy detailed balance conditions, and the proposal satisfies the ergodicity requirement. Further, the acceptance of a proposal can be done such that the Markov chain is reversible, i.e., the product of transition rates over a closed loop of states in the chain is the same in either direction. A reversible Markov chain is also referred to as having detailed balance. Typically, in many cases, the new point is local to the previous point.

The foregoing examples of the related art and limitations related thereto are intended to be illustrative and not exclusive. Other limitations of the related art will become apparent to those of skill in the art upon a reading of the specification and a study of the drawings.

### BRIEF SUMMARY

In some cases where optimization is performed, it may be beneficial to retrieve additional samples, to increase diversity of samples, and to provide additional candidate solutions satisfying a given constraint. The methods and systems described herein beneficially allow for performing optimization or sampling on a processor to generate improved diversity of samples. This may beneficially provide a more diverse set of good solutions, or improve the probability of finding a near global or global minimum for the problem.

Solutions for improving optimization results commonly do not address problems and applications where a useful result is a plurality of good solutions rather than one near optimal solution. In some implementations, programming a quantum computer with an objective function that drives diverse solutions beneficially returns improved solutions for these types of problems.

According to an aspect, there is provided a method of operation of a computing system to return samples having improved diversity, the method being performed by at least one processor, the method comprising receiving a problem definition comprising a problem Hamiltonian defined over a set of variables, sampling one or more values for the set of variables from the problem Hamiltonian, the one or more values for the set of variables comprising a first set of samples, selecting at least a subset of the first set of samples, generating a diversity Hamiltonian based on the at least a subset of the first set of samples, combining the problem Hamiltonian and the diversity Hamiltonian to generate a combined Hamiltonian, and sampling one or more values for the set of variables from the combined Hamiltonian, the one or more values for the set of variables comprising a second set of samples.

According to other aspects, generating a diversity Hamiltonian may comprise generating an anti-Hopfield model for the problem Hamiltonian based on the at least a subset of the first set of samples, selecting at least a subset of the first set of samples may comprise selecting a subset of the first set of samples having a threshold diversity, selecting at least a subset of the first set of samples may comprise selecting a subset of the first set of samples having a threshold solution value, the method may further comprise storing the first set of samples and the second set of samples and/or returning the first set of samples and the second set of samples, sampling one or more values for the set of variables from the problem Hamiltonian may comprise performing a sampling algorithm on the problem Hamiltonian, and wherein sampling one or more values for the set of variables from the combined Hamiltonian comprises performing the sampling algorithm on the combined Hamiltonian, performing the sampling algorithm may comprise performing a Markov Chain Monte Carlo (MCMC) algorithm, performing the MCMC algorithm may comprise performing parallel tempering, sampling one or more values for the set of variables from the problem Hamiltonian may comprise performing an optimization algorithm on the problem Hamiltonian, and sampling one or more values for the set of variables from the combined Hamiltonian may comprise performing the optimization algorithm on the combined Hamiltonian, performing the optimization algorithm may comprise performing simulated annealing, and performing the optimization algorithm comprises performing quantum annealing on a quantum processor.

According to other aspects, generating a diversity Hamiltonian may comprise generating an anti-Hopfield model for the problem Hamiltonian based on the at least a subset of the first set of samples, each of the problem Hamiltonian, the diversity Hamiltonian, and the combined Hamiltonian may define bias values for a plurality of qubits of the quantum processor and coupling values for a plurality of couplers of the quantum processor, the plurality of couplers communicatively coupling the plurality of qubits, and generating the anti-Hopfield model for the problem Hamiltonian may comprise flipping a sign of a coupling term of the problem Hamiltonian, combining the problem Hamiltonian and the diversity Hamiltonian to generate a combined Hamiltonian may comprise adding the diversity Hamiltonian weighted by a diversity parameter to the problem Hamiltonian, sampling one or more values for the set of variables from the problem Hamiltonian may comprise sampling values until an increase in a diversity of the first set of samples is below a first threshold sampling diversity, and sampling one or more values for the set of variables from the combined Hamiltonian may comprise sampling values until an increase in a diversity of the second set of samples is below a second threshold sampling diversity, and the method may further comprise generating a second diversity Hamiltonian based on the at least a subset of the first set of samples and at least a subset of the second set of samples, combining the combined Hamiltonian and the second diversity Hamiltonian to generate a second combined Hamiltonian, and sampling one or more values for the set of variables from the combined Hamiltonian, the one or more values for the set of variables comprising a third set of samples.

According to an aspect, there is provided a method of iteratively operating a computing system to return samples having improved diversity, the method being performed by at least one processor, the method comprising receiving a problem definition comprising a problem Hamiltonian defined over a set of variables, sampling one or more initial values for the set of variables from the problem Hamiltonian, until an increase in a diversity of the sampled initial values is below a first threshold sampling diversity, storing the one or more initial values for the set of variables in a set of samples, iteratively until a termination criteria is met selecting at least a subset of samples from the set of samples, generating a diversity Hamiltonian based on the at least a subset of samples from the set of samples, updating the problem Hamiltonian with the diversity Hamiltonian to generate an updated problem Hamiltonian, sampling one or more additional values for the set of variables from the updated problem Hamiltonian until an increase in a diversity of the sampled additional values is below a second threshold sampling diversity, storing the one or more additional values for the set of variables in the set of samples, and evaluating the termination criteria, and upon meeting the termination criteria, returning the set of samples.

According to other aspects, updating the problem Hamiltonian may comprise adding the diversity Hamiltonian weighted by a diversity parameter to the problem Hamiltonian.

According to an aspect, there is provided a system for use in optimization or sampling, the system comprising at least one non-transitory processor-readable medium that stores at least one of processor executable instructions and data, and at least one processor communicatively coupled to the least one non-transitory processor-readable medium, which, in response to execution of the at least one of processor executable instructions and data, performs one or more of the methods described herein.

In other aspects, the features described above may be combined together in any reasonable combination as will be recognized by those skilled in the art.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements and may have been solely selected for ease of recognition in the drawings.

FIG. 1 is a schematic diagram of a hybrid computing system including a digital computer coupled to an analog computer, in accordance with the present systems, devices, and methods.

FIG. 2 is a schematic diagram of a portion of an example superconducting quantum processor, in accordance with the present systems, devices, and methods.

FIG. 3 is a flow diagram of an example method to return samples having improved diversity, in accordance with the present systems, devices, and methods.

FIG. 4 is a flow diagram of an example iterative method to return samples having improved diversity, in accordance with the present systems, devices, and methods.

FIG. 5 is a diagram of an example implementation of the methods to return samples having improved diversity in accordance with the present systems, devices, and methods.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure, or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

As an illustrative example, a superconducting quantum processor designed to perform adiabatic quantum computation and/or quantum annealing is used in the description that follows. However, as previously described, a person of skill in the art will appreciate that the present systems and methods may be applied to any form of quantum processor hardware (e.g., superconducting, photonic, ion-trap, quantum dot, topological, etc.) implementing any form of quantum algorithm(s) (e.g., adiabatic quantum computation, quantum annealing, gate/circuit-based quantum computing, etc.). A quantum processor may be used in combination with one or more classical or digital processors. Methods described herein may be performed by a classical or digital processor in communication with a quantum processor that implements a quantum algorithm.

### Example Computing System

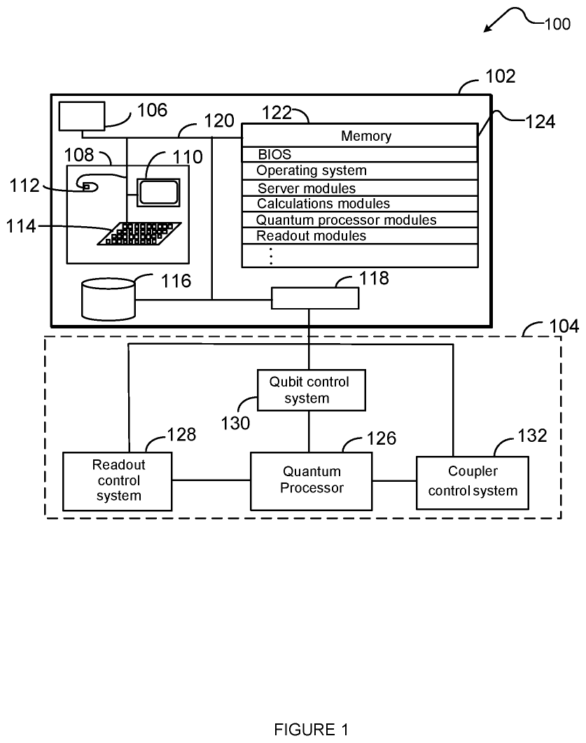

FIG. 1 illustrates a computing system 100 comprising a digital computer 102. The example digital computer 102 includes one or more digital processors 106 that may be used to perform classical digital processing tasks. Digital computer 102 may further include at least one system memory 122, and at least one system bus 120 that couples various system components, including system memory 122 to digital processor(s) 106. System memory 122 may store one or more sets of processor-executable instructions, which may be referred to as modules 124.

The digital processor(s) 106 may be any logic processing unit or circuitry (for example, integrated circuits), such as one or more central processing units (“CPUs”), graphics processing units (“GPUs”), digital signal processors (“DSPs”), application-specific integrated circuits (“ASICs”), programmable gate arrays (“FPGAs”), programmable logic controllers (“PLCs”), etc., and/or combinations of the same.

In some implementations, computing system 100 comprises an analog computer 104, which may include one or more quantum processors 126. Quantum processor 126 may include at least one superconducting integrated circuit. Digital computer 102 may communicate with analog computer 104 via, for instance, a controller 118. Certain computations may be performed by analog computer 104 at the instruction of digital computer 102, as described in greater detail herein.

Digital computer 102 may include a user input/output subsystem 108. In some implementations, the user input/output subsystem includes one or more user input/output components such as a display 110, mouse 112, and/or keyboard 114.

System bus 120 may employ any known bus structures or architectures, including a memory bus with a memory controller, a peripheral bus, and a local bus. System memory 122 may include non-volatile memory, such as read-only memory (“ROM”), static random-access memory (“SRAM”), Flash NAND, and volatile memory such as random-access memory (“RAM”).

Digital computer 102 may also include other non-transitory computer- or processor-readable storage media or non-volatile memory 116. Non-volatile memory 116 may take a variety of forms, including: a hard disk drive for reading from and writing to a hard disk (for example, a magnetic disk), an optical disk drive for reading from and writing to removable optical disks, and/or a solid-state drive (SSD) for reading from and writing to solid state media (for example NAND-based Flash memory). Non-volatile memory 116 may communicate with digital processor(s) via system bus 120 and may include appropriate interfaces or controllers 118 coupled to system bus 120. Non-volatile memory 116 may serve as long-term storage for processor- or computer-readable instructions, data structures, or other data (sometimes called program modules or modules 124) for digital computer 102.

Although digital computer 102 has been described as employing hard disks, optical disks and/or solid-state storage media, those skilled in the relevant art will appreciate that other types of nontransitory and non-volatile computer-readable media may be employed. Those skilled in the relevant art will appreciate that some computer architectures employ nontransitory volatile memory and nontransitory non-volatile memory. For example, data in volatile memory may be cached to non-volatile memory. Or a solid-state disk that employs integrated circuits to provide non-volatile memory.

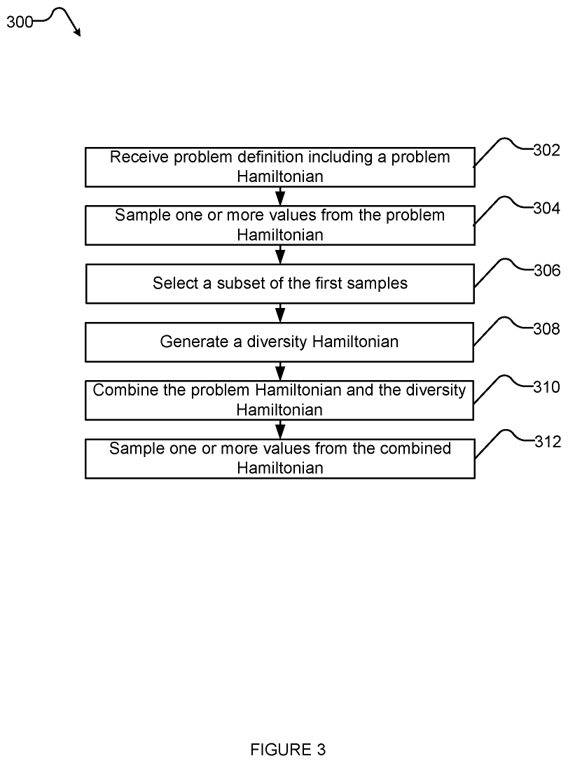

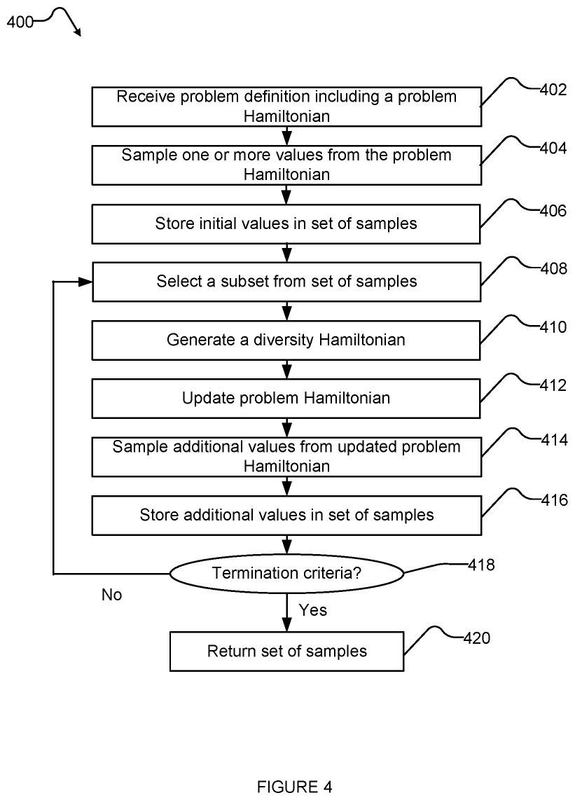

Various processor- or computer-readable and/or executable instructions, data structures, or other data may be stored in system memory 122. For example, system memory 122 may store instructions for communicating with remote clients and scheduling use of resources including resources on the digital computer 102 and analog computer 104. Also, for example, system memory 122 may store at least one of processor executable instructions or data that, when executed by at least one processor, causes the at least one processor to execute the various algorithms to execute instructions. In some implementations system memory 122 may store processor- or computer-readable calculation instructions and/or data to perform pre-processing, co-processing, and post-processing to analog computer 104. System memory 122 may store a set of analog computer interface instructions to interact with analog computer 104. For example, the system memory 122 may store processor- or computer-readable instructions, data structures, or other data which, when executed by a processor or computer causes the processor(s) or computer(s) to execute one, more or all of the acts of the methods 300 (FIG. 3) or 400 (FIG. 4).

Analog computer 104 may include at least one analog processor such as quantum processor 126. Analog computer 104 may be provided in an isolated environment, for example, in an isolated environment that shields the internal elements of the quantum computer from heat, magnetic field, and other external noise. The isolated environment may include a refrigerator, for instance a dilution refrigerator, operable to cryogenically cool the analog processor, for example to temperatures below approximately 1 K.

Analog computer 104 may include programmable elements such as qubits, couplers, and other devices (also referred to herein as controllable devices). Qubits may be read out via readout system 128. Readout results may be sent to other computer- or processor-readable instructions of digital computer 102. Qubits may be controlled via a qubit control system 130. Qubit control system 130 may include on-chip Digital to Analog Converters (DACs) and analog lines that are operable to apply a bias to a target device. Couplers that couple qubits may be controlled via a coupler control system 132. Coupler control system 132 may include tuning elements such as on-chip DACs and analog lines. Qubit control system 130 and coupler control system 132 may be used to implement a quantum annealing schedule as described herein on analog computer 104. Programmable elements may be included in quantum processor 126 in the form of an integrated circuit. Qubits and couplers may be positioned in layers of the integrated circuit that comprise a first material. Other devices, such as readout control system 128, may be positioned in other layers of the integrated circuit that comprise a second material. Quantum processors may perform two general types of quantum computation. The first, quantum annealing and/or adiabatic quantum computation, generally relies on the physical evolution of a quantum system. Gate, or circuit, model quantum computation relies on the use of quantum gate operations to perform computations with data. In accordance with the present disclosure, a quantum processor, such as quantum processor 126, may perform quantum annealing and/or adiabatic quantum computation or may perform gate or circuit model quantum computation. Example implementations of quantum processors are described in U.S. Pat. No. 7,533,068 and U.S. Provisional Patent Application No. 63/356,663.

### Example Superconducting Quantum Processor

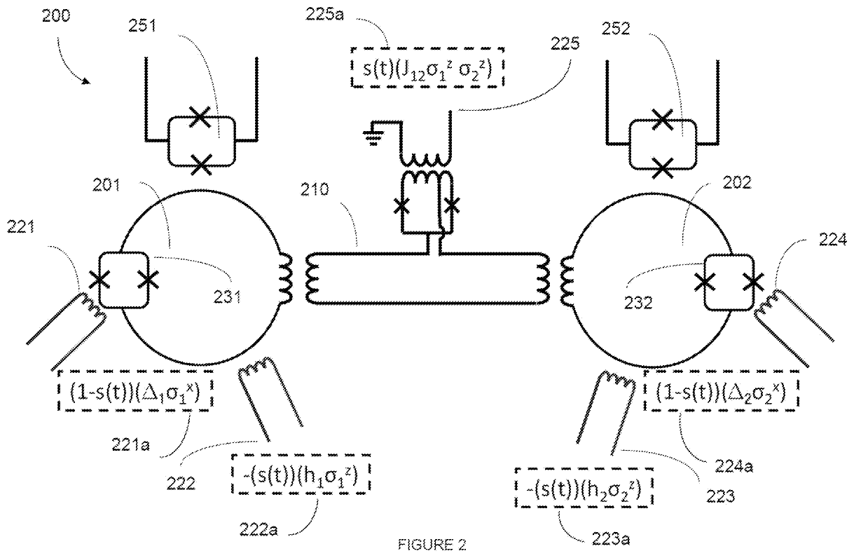

FIG. 2 is a schematic diagram of a portion of an example superconducting quantum processor 200, according to at least one implementation. In some implementations example superconducting quantum processor 200 may be quantum processor 126 of analog computer 104 as shown in FIG. 1 and discussed above. The portion of superconducting quantum processor 200 shown in FIG. 2 includes two qubits (e.g., superconducting qubits 201, and 202). Also shown is a tunable coupling via coupler 210 between qubits 201 and 202 (e.g., a diagonal coupling providing 2-local interaction). While the portion of quantum processor 200 shown in FIG. 2 includes only two qubits 201, 202 and one coupler 210, those of skill in the art will appreciate that quantum processor 200 may include any number of qubits and any number of couplers coupling information between them.

Quantum processor 200 includes a plurality of interfaces 221, 222, 223, 224, 225 that are used to configure and control the state of quantum processor 200. Each of interfaces 221-225 may be realized by a respective inductive coupling structure, as illustrated, as part of a programming subsystem and/or an evolution subsystem. Alternatively, or in addition, interfaces 221-225 may be realized by a galvanic coupling structure. In some implementations, one or more of interfaces 221-225 may be driven by one or more DACs. Such a programming subsystem and/or evolution subsystem may be separate from quantum processor 200, or may be included locally (i.e., on-chip with quantum processor 200). Interfaces 221-225 may be part of readout control system 128, qubit control system 130, and/or coupler control system 132 as discussed with respect to analog computer 104 of FIG. 1.

In the operation of quantum processor 200, interfaces 221 and 224 may each be used to couple a flux signal into a respective compound Josephson junction 231 and 232 of qubits 201 and 202, thereby realizing a tunable tunneling term (the Δᵢ term) in the system Hamiltonian. This coupling provides the off-diagonal σ^{x} terms of the Hamiltonian and these flux signals are examples of “delocalization signals”. Examples of Hamiltonians (and their terms) used in quantum computing are described in greater detail in, for example, U.S. Patent Application Publication No. 2014/0344322.

Similarly, interfaces 222 and 223 may each be used to apply a flux signal into a respective qubit loop of qubits 201 and 202, thereby realizing the hᵢ terms (dimensionless local fields for the qubits) in the system Hamiltonian. This coupling provides the diagonal σ^{z} terms in the system Hamiltonian. Furthermore, interface 225 may be used to couple a flux signal into coupler 210, thereby realizing the Jᵢⱼ term(s) (dimensionless local fields for the couplers) in the system Hamiltonian. This coupling provides the diagonal of σᵢ^{z}σⱼ^{z} terms in the system Hamiltonian.

In FIG. 2, the contribution of each of interfaces 221-225 to the system Hamiltonian is indicated in boxes 221a, 222a, 223a, 224a, 225a, respectively. As shown, in the example of FIG. 2, the boxes 221a-225a are elements of time-varying Hamiltonians for quantum annealing and/or adiabatic quantum computing.

While FIG. 2 illustrates only two physical superconducting qubits 201, 202, one coupler 210, and two readout devices 251, 252, a quantum processor (e.g., quantum processor 200) may employ any number of qubits, couplers, and/or readout devices, including a larger number (e.g., hundreds, thousands or more) of qubits, couplers and/or readout devices. Examples of superconducting qubits include superconducting flux qubits, superconducting charge qubits, and the like. In a superconducting flux qubit, the Josephson energy dominates or is equal to the charging energy. In a charge qubit this is reversed. Examples of flux qubits that may be used include radio frequency superconducting quantum interference devices, which include a superconducting loop interrupted by one Josephson junction, persistent current qubits, which include a superconducting loop interrupted by three Josephson junctions, and the like.

### Diversity in Optimization and Sampling

Optimization algorithms use a variety of techniques to search or explore a solution space to attempt to determine an optimal solution. In many cases, local extrema (minima or maxima) may cause an optimization algorithm to return a less than optimal solution. In order to reduce the risk of returning a local extrema rather than a global extrema, optimization algorithms may benefit from the exploration of diverse solutions within the solution space in order to converge to the optimal solution or a more optimal solution. Increasing diversity of the results may speed up the search for optimal or more optimal solutions.

In addition, while for some problems it is desirable to find the optimal or closest to optimal solution, for other problems it is desirable to have an algorithm return a set of high-quality and diverse solutions instead of a single optimal one. Diversity of high-performing samples may be important in applications such as genetic programming, evolutionary algorithms, quality-diversity optimization, contingency planning, robust optimization, and machine learning applications. Examples of problems where diverse solutions are beneficial include game playing strategies where multiple good solutions are more useful than a single “best” solution, new drug discovery where multiple candidate compounds are desired, personnel scheduling where last minute changes may occur and multiple good schedules are useful, or vehicle routing problems where alternative paths may be useful, such as for unexpected events. A further discussion of the merits of solution diversity can be found in Zucca et al., Diversity metric for evaluation of quantum annealing, arXiv:2110.10196v2, Oct. 23, 2021.

Discussed herein is a method that includes modifying an Ising Hamiltonian to drive an optimization search to areas of the solution space that have not been explored and to increase the diversity of returned solutions. This method will be discussed below in the context of binary quadratic models; however, it will be understood that the techniques discussed herein may be applied to other types of models. The methods described herein may be used with sampling algorithms such as parallel tempering, and may also be extended to optimization algorithms such as simulated annealing and quantum annealing.

Methods for exploring new regions of solutions space may include Houdayer cluster moves as described in Houdayer, A Cluster Monte Carlo Algorithm for 2-Dimensional Spin Glasses, arXiv:cond-mat/0101116v3, May 28, 2001, and isogenic cluster moves as described in Zhu et al., Efficient Cluster Algorithm for Spin Glasses in Any Space Dimension, arXiv:1501.05630v2, Aug. 15, 2015. However, these techniques typically work on low dimensional lattices or generally below the percolation threshold for spin glasses, as discussed in Zhu et al. As such, the methods discussed herein may beneficially be applied to other types of problems. The present method may be used to generate a greater number and diversity of unique solutions. It can be incorporated into sampling and optimization algorithms to guide the search to new regions of the solution space.

FIG. 3 is a flow diagram of an example method 300 of operation of a computing system to return samples having improved diversity. Method 300 may be executed on a classical computing system, or on a hybrid computing system with at least one digital or classical processor and a quantum processor, for example, hybrid computing system 100 of FIG. 1.

Method 300 comprises acts 302 to 312; however, a person skilled in the art will understand that the number of acts illustrate is an example, and, in some implementations, certain acts may be omitted, further acts may be added, and/or the order of the acts may be changed.

Method 300 starts at act 302, for example, in response to a call from another routine.

At 302, the processor receives a problem definition comprising a problem Hamiltonian defined over a set of variables. For example, the set of variables might be given by xᵢ, and the problem Hamiltonian might be given as:

$$H = {\sum }_{i} {h}_{i} {x}_{i} + {\sum }_{i , j} {J}_{ij} {x}_{i} {x}_{j}$$

At 304, the processor samples one or more values for the set of variables from the problem Hamiltonian, the one or more values for the set of variables comprising a first set of samples. In some implementations this may include performing a sampling or optimization algorithm on the problem Hamiltonian. In some implementations the sampling algorithm may be a Markov Chain Monte Carlo (MCMC) algorithm such as parallel tempering. In other implementations the optimization algorithm may be simulated annealing or quantum annealing performed on a quantum processor. The processor may sample values by instructing a quantum processor to perform quantum annealing one or more times and receiving the results of the anneal(s). In some implementations, sampling one or more values for the set of variables from the problem Hamiltonian includes sampling values until an increase in a diversity of the first set of samples is below a first threshold sampling diversity. That is, sampling is performed until the samples returned are no longer providing a threshold level of diversity. In some implementations, a diversity metric may include a mutual Hamming distance, or an approximated diversity measure as described in Zucca et al., Diversity metric for evaluation of quantum annealing, arXiv:2110.10196v2, Oct. 23, 2021. A threshold level of diversity may be selected in a model or problem dependent manner. For example, in some implementations a threshold diversity may be selected as a percentage of an initial diversity of samples. In other implementations adaptive algorithms may be used to determine a threshold level of diversity. For example, an adaptive algorithm may have a higher threshold level of diversity at a start of sampling when sample diversity is high, and a lower threshold level of diversity as sample diversity decreases later in sampling. A threshold level of diversity may also depend on the number of variables in the problem as well as other factors known in the art. In some implementations, sampling is performed until the diversity of the overall set of samples stops increasing. For example, when using the diversity measure defined in Zucca et al. above, sampling can be performed until new samples have the same diversity as the sample set of the previous samples. In other implementations a threshold may be provided by a user or generated by another algorithm. Other metrics, such as a length of time or a number of samples may also be used.

In implementations where performing optimization includes performing quantum annealing on a quantum processor, the quantum processor samples the one or more values for the set of variables by performing an annealing evolution and reading out the resulting states of the qubits. The quantum processor can have a plurality of qubits and a plurality of couplers as discussed with reference to FIGS. 1 and 2, and the problem Hamiltonian can be programmed onto the quantum processor using bias values applied to the qubits and coupling values applied to the couplers, the plurality of qubits can be evolved, and the final states of the plurality of qubits can be returned as defining values for the variables in the sample.

In an example implementation, the problem may be a binary quadratic model (BAM) that includes a problem Hamiltonian. A set of solutions or samples may be provided by a variety of methods. For example, quantum annealing may be performed to provide a set of low energy solutions. These solutions may be represented by {εᵢ^{p}}_{i=1, . . . ,N,p=1 . . . , M} where N is the number of variables of the problem being solved and M is the number of solutions that have been found and stored, such as in a memory, for example, memory 122 of digital computer 102 of FIG. 1.

At 306, the processor selects at least a subset of the first set of samples. In some implementations, this may be a subset of the first set of samples having a threshold diversity or a subset of the first set of samples having a threshold solution value.

At 308, the processor generates a diversity Hamiltonian based on the at least a subset of the first set of samples. The diversity Hamiltonian may, in some implementations, be an anti-Hopfield model for the problem Hamiltonian based on the at least a subset of the first set of samples. In some implementations, generating the anti-Hopfield model for the problem Hamiltonian may include flipping a sign of a coupling term of the problem Hamiltonian.

The diversity Hamiltonian may be defined as an anti-Hopfield model Hamiltonian for the problem Hamiltonian. A Hopfield model, as discussed in Hopfield, J., Neural networks and physical systems with emergent collective computational abilities, Proc. Natl. Acad. Sci. USA, Vol. 79, pp. 2554-2558, April 1982, Biophysics, is a model that uses a history of samples and can generate a coupling (or interaction) term between variables based on the history of states. An anti-Hopfield model, as discussed in Nokura, K., Spin glass states of the anti-Hopfield model, J. Phys. A: Math. Gen. 31 7447, 1988, has an opposite interactional sign on the interaction, or coupling, term. As used herein, the anti-Hopfield model beneficially motivates searching for spin configurations that are as orthogonal as possible to all previous samples.

Consider the Ising Hamiltonian: H=Σ_{i<j}Jᵢⱼsᵢsⱼ where sᵢ∈{±1}. According to the Hopfield model, the couplers may be set in the following way:

$${J}_{ij} = - \frac{1}{N} {\sum }_{p = 1}^{M} {ε}_{i}^{p} {ε}_{j}^{p} .$$

Assuming only one sample has been retrieved, M=1. The coupling term is given by: Jᵢⱼ=−εᵢ¹≥ⱼ¹, and the Hopfield Hamiltonian becomes:

$$H = - \frac{1}{N} {\sum }_{i < j} {ε}_{i}^{1} {ε}_{j}^{1} {s}_{i} {s}_{j} .$$

The ground state is given by two possibilities. The first, s₁=ε¹, is where the Hopfield model ground state is aligned with or parallel to the sample ε¹. This can be checked by inspection:

$${H}_{ε} = - \frac{1}{N} {\sum }_{i < j} {( {ε}_{i}^{1} )}^{2} {( {ε}_{j}^{1} )}^{2} = - \frac{1}{N} \frac{N ( N - 1 )}{2} = - \frac{N - 1}{2} .$$

The second ground state, s₁=−ε¹, is where the Hopfield model ground state is anti-parallel, or neither aligned with nor parallel to, the sample ε¹.

If the sign of the coupling term Jᵢⱼ is flipped, the Hamiltonian discussed above for one sample becomes:

$$H = \frac{1}{N} {\sum }_{i < j} {ε}_{i}^{1} {ε}_{j}^{1} {s}_{i} {s}_{j} .$$

In this case, the solution is: sᵢ=±εᵢ¹, which provides the maximum possible energy. The ground state will be the solution as far away as possible from the sample ±εᵢ¹. This describes an anti-Hopfield Hamiltonian.

Assuming that more than one sample has been retrieved, and considering the Hopfield model, samples will be local minima of the problem Hamiltonian H, where local is defined in the context of the Hamming distance. Similarly, the corresponding anti-Hopfield Hamiltonian will have local minima that are states as far as possible from the given samples. When a set of samples (e.g., a set of good solutions of the problem Hamiltonian currently being solved) have been received, the search can beneficially be driven away from this known set of samples by sampling from the corresponding anti-Hopfield model.

At 310, the processor combines the problem Hamiltonian and the diversity Hamiltonian to generate a combined Hamiltonian. In some implementations, combining the problem Hamiltonian and the diversity Hamiltonian to generate a combined Hamiltonian may include adding the diversity Hamiltonian weighted by a diversity parameter to the problem Hamiltonian. In some implementations, the problem Hamiltonian can be modified by changing the model to: H′=H_{model}+αH_{AH}, where α>0 is a parameter that encodes a desired strength of solution diversity and H_{AH} denotes the anti-Hopfield Hamiltonian built by the collected samples as discussed above. Optimization can then be performed on the Hamiltonian H′. A heuristic to determine a is discussed in detail below.

In some implementations, each of the problem Hamiltonian, the diversity Hamiltonian, and the combined Hamiltonian define bias values for a plurality of qubits of the quantum processor and coupling values for a plurality of couplers of the quantum processor, the plurality of couplers communicatively coupling the plurality of qubits.

At 312, the processor samples one or more values for the set of variables from the combined Hamiltonian, the one or more values for the set of variables comprising a second set of samples. In some implementations this may include performing the sampling or optimization algorithm used in act 304 on the combined Hamiltonian. In some implementations, values are sampled from the combined Hamiltonian until an increase in a diversity of the second set of samples is below a second threshold sampling diversity. In other words, sampling is performed until new samples no longer increase the diversity of the set of samples, or no longer significantly increase the diversity of the set of samples, for example, where diversity is increasing by less than a fixed value or a fixed percentage. Other implementations of thresholds are discussed in further detail above with respect to act 304.

In some implementations, the quality of the sample solutions may be assessed in comparison to the samples in the first set of samples, and only the solutions with a sufficiently high quality may be included in a second set of samples. That is, if the samples generated by the combined Hamiltonian are significantly lower quality (less optimal) with respect to the problem Hamiltonian than the first set of samples, they may not be considered to have sufficient quality. In some implementations, where returned samples are not of sufficient quality with respect to the original problem Hamiltonian, the diversity Hamiltonian may be rejected and a new diversity Hamiltonian may be generated, for example, by tuning a.

After act 312, method 300 terminates, unless it is iterated, or until it is, for example, invoked again.

In some implementations the processor optionally stores the first set of samples and the second set of samples such that they may be retrieved after the completion of method 300, such as in memory 122 or memory 116 of digital computer 102 of FIG. 1. The processor may also return the first set of samples and the second set of samples, such as to a user. In other implementations a subset of samples may be stored and/or returned. For example, a subset selected from the first set of samples and the second set of samples having the best solution quality and/or the highest diversity may be returned to a user. It will be understood that samples from the first set of samples will be all of or a subset of the best (most optimal, also referred to as highest quality) samples found by sampling with the initial problem Hamiltonian, while the samples from the second set of samples will be all of or a subset of the best (most optimal) samples found by sampling with the diversity Hamiltonian. The first set of samples and the second set of samples together represent a sample set beneficially having increased diversity in comparison to sampling from the initial problem Hamiltonian or from the diversity Hamiltonian in isolation.

In some implementations, method 300 may optionally be extended to include generating a second diversity Hamiltonian based on the at least a subset of the first set of samples and at least a subset of the second set of samples, combining the combined Hamiltonian and the second diversity Hamiltonian to generate a second combined Hamiltonian, and sampling one or more values for the set of variables from the combined Hamiltonian, in which the one or more values for the set of variables comprise a third set of samples. Similar extensions of method 300 may be applied any number of times.

As discussed above, in some implementations, a diversity parameter a may be included to weight the contribution of the diversity Hamiltonian when added to the problem Hamiltonian. Tuning the parameter a determines a balance between diversity of solutions and optimal solutions. If a value of a is small, the model H′ will be similar to H_{model}, and diversity will not be encouraged. If the value of α is large, H′ will not return optimal solutions and will only provide solutions that are as diverse as possible. A working range for α may be heuristically obtained as follows, assuming the sampling algorithm performs single spin flips, as in many MCMC algorithms such as parallel tempering and simulated annealing, or as in quantum annealing.

Given a Hamiltonian: H=Σᵢhᵢsᵢ+Σ_{i<j}Jᵢⱼsᵢsⱼ, the energy change when flipping variable i is given by: ΔEᵢ=2(hᵢ+Σ_{j≠t}Jᵢⱼsⱼ). An upper bound to the maximum possible gain in energy when sweeping variables is given by:

$$Δ {E}_{max} = 2 {max}_{i} ( {h}_{i} + {\sum }_{j \neq i} \vert {J}_{ij} \vert ) ,$$

Σ_{j≠i}|Jᵢⱼ|), while the minimum possible energy is given by:

$$Δ {E}_{min} = {min}_{i} \vert {h}_{i} \vert .$$

A reasonable upper bound on α may be obtained by imposing a constraint that the minimum possible gain in the energy of the objective function is larger than the maximum possible gain in diversity, i.e.,

$${min}_{i} \vert {h}_{i}^{model} \vert > α {max}_{i} [ {h}_{i}^{AH} + {\sum }_{j \neq i} \vert {J}_{ij}^{AH} \vert ] , or α < \frac{{min}_{i} \vert {h}_{i}^{model} \vert}{{max}_{i} \vert {h}_{i}^{AH} \vert + {\sum }_{j} \vert {J}_{ij}^{AH} \vert} .$$

FIG. 4 is a flow diagram of an example method 400 of operation of a computing system to return samples having improved diversity. Method 400 is an iterative version of the implementation of method 300. Iterations may be performed until a sufficiently large and diverse sample set having sufficiently high quality has been generated for a particular application. Each iteration creates an updated problem Hamiltonian that will explore a new region of the sample space to provide more diverse samples. It will be understood that the features discussed above with respect to method 300 may equally be used with method 400. Method 400 may be executed on a classical computing system, or on a hybrid computing system with at least one digital or classical processor and a quantum processor, for example, hybrid computing system 100 of FIG. 1.

Method 400 comprises acts 402 to 420; however, a person skilled in the art will understand that the number of acts illustrate is an example, and, in some implementations, certain acts may be omitted, further acts may be added, and/or the order of the acts may be changed.

Method 400 starts at act 402, for example, in response to a call from another routine.

At 402, the processor receives a problem definition comprising a problem Hamiltonian defined over a set of variables.

At 404, the processor samples one or more initial values for the set of variables of the problem Hamiltonian, until an increase in a diversity of the sampled initial values is below a first threshold sampling diversity.

At 406, the processor stores the one or more initial values for the set of variables in a set of samples.

At 408 an iterative process that includes acts 408 through 418 is started, and the processor selects at least a subset of samples from the current set of samples at each iteration, for example, in a similar fashion to that described with respect to act 306 of method 300 (FIG. 3).

At 410, the processor generates a diversity Hamiltonian based on the at least a subset of samples from the set of samples, for example, in a similar fashion to that described with respect to act 308 of method 300 (FIG. 3).

At 412, the processor updates the problem Hamiltonian with the diversity Hamiltonian to generate an updated problem Hamiltonian. In some implementations, updating the problem Hamiltonian may comprise adding the diversity Hamiltonian weighted by a diversity parameter to the problem Hamiltonian.

At 414, the processor samples one or more additional values for the set of variables from the updated problem Hamiltonian until an increase in a diversity of the sampled additional values is below a second threshold sampling diversity. As discussed above, the quality of the additional values with respect to the problem Hamiltonian may also be evaluated.

At 416, the processor stores the one or more additional values for the set of variables in the set of samples.

At 418, the processor evaluates a termination criteria. The termination criteria may, for example, be a number of iterations, a diversity measure for the set of samples, a time duration, and/or another metric. When the termination criteria has not been met, control passes back to act 408. When the termination criteria has been met, control passes to act 420.

At 420, the processor returns the set of samples.

In some implementations a computing system, such as computing system 100 of FIG. 1, which may include a digital processor such as digital processor 106 or a digital processor in communication with a quantum processor such as quantum processor 126, may be provided. The computing system includes at least one non-transitory processor-readable medium that stores at least one of processor executable instructions and data such as memory 122 and at least one processor communicatively coupled to the least one non-transitory processor-readable medium, such as digital processor 106, which, in response to execution of the at least one of processor executable instructions and data, performs any of the methods discussed above.

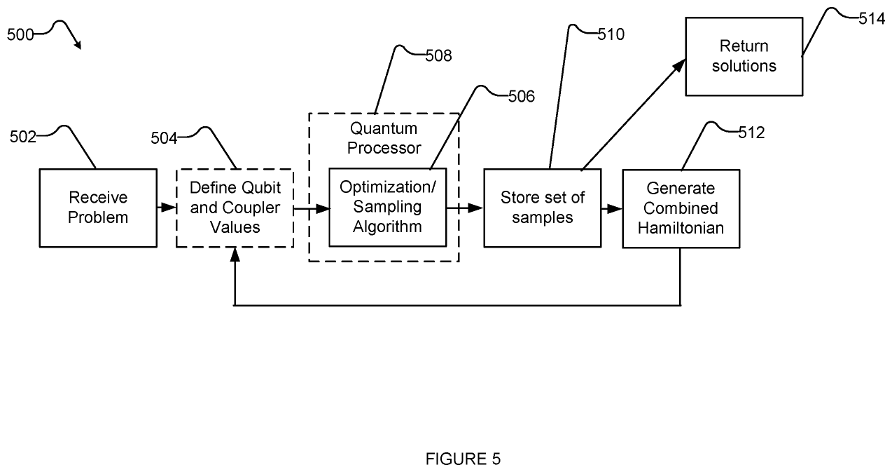

FIG. 5 is a diagram with an example implementation 500 of the methods above. The methods described above may be incorporated into algorithms such as simulated annealing or quantum annealing that solves or samples from a Hamiltonian. The algorithm returns M samples each time it runs.

At 502, a problem is received by at least one processor, such as a classical or digital processor or a quantum processor. The problem is defined by at least a problem Hamiltonian H_{model} over a set of variables.

At 504, the Hamiltonian is optionally converted by the at least one processor into bias values for a plurality of qubits of a quantum processor and coupling values for a plurality of couplers of a quantum processor, the plurality of couplers communicatively coupling the plurality of qubits. For example, qubits of the plurality of qubits may be qubits 201 and 202 and one of the plurality of couplers may be coupler 210 of quantum processor 200 of FIG. 2. Act 504 may be performed by a classical or digital processor in communication with a quantum processor, or may be performed by a programming subsystem of a quantum processor directly.

At 506, the problem Hamiltonian is passed to the optimization or sampling algorithm (e.g., setting H⁽⁰⁾=H_{model}) and at least one processor runs or executes the optimization algorithm. Optionally, the classical or digital processor calls or invokes a quantum processor 508 to perform the optimization or sampling algorithm based on the bias and coupling values determined during act 504.

At 510, a set of samples are returned by the optimization or sampling algorithm. In each iteration, all, or a subset, of the samples returned from the optimization or sampling algorithm are added to the set of samples.

At 512, the processor creates a diversity Hamiltonian, e.g., an anti-Hopfield model H_{AH}⁽⁰⁾ with all or a subset of the set of samples obtained from the optimization or sampling algorithm. The diversity Hamiltonian is then added to the problem Hamiltonian, and may be weighted by a diversity parameter. For example, a combined Hamiltonian H⁽¹⁾ may be generated by setting H⁽¹⁾=H_{model}+α⁽¹⁾H_{AH}⁽⁰⁾. The new Hamiltonian H⁽¹⁾ may then be submitted to the optimization or sampling algorithm. The combined Hamiltonian may be returned to optional act 504 and used to determine new bias and coupling values, or the combined Hamiltonian may be returned to act 506.

At 514, after some termination criteria has been met by the set of samples at act 510, control passes to act 514, where all or a portion of the set of samples is stored as solutions, passed to another program or algorithm, and/or returned to a user as solutions. As discussed above, a subset of the set of samples may be selected having the best (e.g., lowest energy) and/or most diverse samples to return as solutions. The termination criteria may, for example, be a number of iterations, a diversity measure for the set of samples, a time duration, and/or another metric.

At each iteration i, the optimization or sampling algorithm solves or samples a Hamiltonian H⁽ⁱ⁾=H_{model}+α⁽ⁱ⁾H_{AH}⁽ⁱ⁻¹⁾, where α⁽ⁱ⁾ may be iteration dependent and H_{AH}⁽ⁱ⁻¹⁾ is a diversity Hamiltonian such as an anti-Hopfield Hamiltonian built with the set or a subset of the samples obtained in the first i iterations. The subset may, for example, be selected using quality and diversity metrics and updated at each iteration.

The methods discussed above may be combined with other optimization algorithms. For example, when solving a constrained quadratic model as discussed in International Application Number PCT/US22/22596, the diversity Hamiltonian may be added to the objective function, such that the constraint functions remain the same and the solutions produced are both feasible and more diverse. Considering the optimization methods described in United States Patent Application Publication No. US 2020/0234172, the methods described above may be combined with the described quantum optimization to generate an alternative optimization act. In the described algorithm of the referenced application in light of the present methods, an alternative hybrid move act is generated. Samples may be stored to collect good quality and diverse solutions. Each time the hybrid move act is be performed, the anti-Hopfield Hamiltonian H_{AH} may be built and added to the model Hamiltonian H_{model} as discussed above to give H′=H_{model}+αH_{AH}. This Hamiltonian H′ is compressed given the clusters discovered by quantum hammer and sent to the QPU.

A pseudocode for an example implementation of the method discussed above is provided as follows:
Define an object CONTAINER that stores samples:
H_{AH} CONTAINER Alternatively, pass SAMPLES to the container so that it stores the samples.

In some implementations, a portion of the samples may be eliminated, such as samples having a similar quality and low diversity.
CONTAINER(SAMPLES)
   Integration into a Parallel Tempering Algorithm:

Input: Hamiltonian H, number of sweeps n_{sw}, random initial states STATES, value or function α to tune the ratio diversity and quality of solutions, number of sweeps n_{sw}^{impr} to perform after which the Hamiltonian will be modified, if there is no improvement.
FOR i_{sweep}=1, . . . , n_{sw} DO:
NEW STATES, NEW ENERGIES SWEEP replicas (STATES)
CONTAINER(NEW STATES)
IF no improvement in lowest ENERGY recorded in the last n_{sw}^{impr}:
H_{AH} CONTAINER

HH+αH_{AH}
END IF
STATES NEW STATES

### Black-Box Optimization Algorithm

Input: Hamiltonian H, number of iterations nᵢₜₑᵣ, value or function α, a black-box OPTIMIZATION algorithm.

Initialize empty container.

H⁽⁰⁾<←H
FOR i=1, . . . , nᵢₜₑᵣ DO:
STATES, ENERGY OPTIMIZATION(H⁽ⁱ⁻¹⁾)
CONTAINER (STATES)
H_{AH}ⁱ CONTAINER

H⁽ⁱ⁾←H+αH_{AH}⁽ⁱ⁾

The methods and systems described herein beneficially allow for performing optimization or sampling on a processor to generate improved diversity of samples and hence improve the performance of a processor-based system. This may beneficially provide a more diverse set of good solutions, and/or improve the probability of finding a near global or global minimum for the problem.

A diversity Hamiltonian such as the anti-Hopfield model can be beneficially used to propose moves that are far away from all the solutions encountered so far. When sampling from a model defined by a Hamiltonian H_{model} with a MCMC algorithm such as parallel tempering, the sampling begins with sampling from H_{model}, and keeps track of solutions of good quality that are diverse. The number of diverse solutions may be limited to a maximum number M. When there is no improvement in the lowest temperature replica for a pre-selected number of sweeps, a diversity Hamiltonian may be found.

The above described method(s), process(es), or technique(s) could be implemented by a series of processor readable instructions stored on one or more nontransitory processor-readable media. Some examples of the above described method(s), process(es), or technique(s) method are performed in part by a specialized device such as an adiabatic quantum computer or a quantum annealer, a gate, or circuit, model quantum computer, or a system to program or otherwise control operation of an adiabatic quantum computer, a quantum annealer, or a gate, or circuit, model quantum computer, for instance a computer that includes at least one digital processor. The above described method(s), process(es), or technique(s) may include various acts, though those of skill in the art will appreciate that in alternative examples certain acts may be omitted and/or additional acts may be added. Those of skill in the art will appreciate that the illustrated order of the acts is shown for example purposes only and may change in alternative examples. Some of the example acts or operations of the above described method(s), process(es), or technique(s) are performed iteratively. Some acts of the above described method(s), process(es), or technique(s) can be performed during each iteration, after a plurality of iterations, or at the end of all the iterations.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other methods of quantum computation, not necessarily the example methods for quantum computation generally described above.

The various implementations described above can be combined to provide further implementations. All of the commonly assigned U.S. patent application publications, U.S. patent applications, foreign patents, and foreign patent applications referred to in this specification and/or listed in the Application Data Sheet are incorporated herein by reference, in their entirety, including but not limited to:
U.S. Provisional Patent Application No. 62/951,749.
U.S. Patent Application Publication Nos. 2014/0344322 and 2020/0234172.
U.S. Pat. Nos. 7,533,068; 8,008,942; 8,195,596; 8,190,548; and 8,421,053.
International Application Number PCT/US22/22596.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method of operation of a computing system to return samples having improved diversity, the method being performed by at least one processor, the method comprising:
receiving a problem definition comprising a problem Hamiltonian defined over a set of variables;
sampling one or more values for each variable of the set of variables from the problem Hamiltonian, the one or more values for each variable of the set of variables comprising a first set of samples;
selecting at least a subset of the first set of samples;
generating a diversity Hamiltonian based on the at least a subset of the first set of samples;
combining the problem Hamiltonian and the diversity Hamiltonian to generate a combined Hamiltonian; and
sampling one or more values for the set of variables from the combined Hamiltonian, the one or more values for the set of variables comprising a second set of samples.

2. The method of claim 1, wherein generating a diversity Hamiltonian comprises generating an anti-Hopfield model for the problem Hamiltonian based on the at least a subset of the first set of samples.

3. The method of claim 1, wherein selecting at least a subset of the first set of samples comprises selecting a subset of the first set of samples having a threshold diversity.

4. The method of claim 1, wherein selecting at least a subset of the first set of samples comprises selecting a subset of the first set of samples having a threshold solution value.

5. The method of claim 1, further comprising storing the first set of samples and the second set of samples.

6. The method of claim 1, further comprising returning the first set of samples and the second set of samples.

7. The method of claim 1, wherein sampling one or more values for the set of variables from the problem Hamiltonian comprises performing a sampling algorithm on the problem Hamiltonian, and wherein sampling one or more values for the set of variables from the combined Hamiltonian comprises performing the sampling algorithm on the combined Hamiltonian.

8. The method of claim 7, wherein performing the sampling algorithm comprises performing one of a Markov Chain Monte Carlo (MCMC) algorithm and a parallel tempering algorithm.

9. The method of claim 1, wherein sampling one or more values for the set of variables from the problem Hamiltonian comprises performing an optimization algorithm on the problem Hamiltonian, and wherein sampling one or more values for the set of variables from the combined Hamiltonian comprises performing the optimization algorithm on the combined Hamiltonian.

10. The method of claim 9 wherein performing the optimization algorithm comprises performing simulated annealing.

11. The method of claim 10, wherein performing the optimization algorithm comprises performing quantum annealing on a quantum processor.

12. The method of claim 11, wherein:
generating a diversity Hamiltonian comprises generating an anti-Hopfield model for the problem Hamiltonian based on the at least a subset of the first set of samples;
each of the problem Hamiltonian, the diversity Hamiltonian, and the combined Hamiltonian define bias values for a plurality of qubits of the quantum processor and coupling values for a plurality of couplers of the quantum processor, the plurality of couplers communicatively coupling the plurality of qubits; and
generating the anti-Hopfield model for the problem Hamiltonian comprises flipping a sign of a coupling term of the problem Hamiltonian.

13. The method of claim 1, wherein combining the problem Hamiltonian and the diversity Hamiltonian to generate a combined Hamiltonian comprises adding the diversity Hamiltonian weighted by a diversity parameter to the problem Hamiltonian.

14. The method of claim 13, wherein:
sampling one or more values for the set of variables from the problem Hamiltonian comprises sampling values until an increase in a diversity of the first set of samples is below a first threshold sampling diversity; and
sampling one or more values for the set of variables from the combined Hamiltonian comprises sampling values until an increase in a diversity of the second set of samples is below a second threshold sampling diversity.

15. The method of claim 14, further comprising:
generating a second diversity Hamiltonian based on the at least a subset of the first set of samples and at least a subset of the second set of samples;
combining the combined Hamiltonian and the second diversity Hamiltonian to generate a second combined Hamiltonian; and
sampling one or more values for the set of variables from the combined Hamiltonian, the one or more values for the set of variables comprising a third set of samples.

16. A method of iteratively operating a computing system to return samples having improved diversity, the method being performed by at least one processor, the method comprising:
receiving a problem definition comprising a problem Hamiltonian defined over a set of variables;
sampling one or more initial values for each variable of the set of variables from the problem Hamiltonian, until an increase in a diversity of the sampled initial values is below a first threshold sampling diversity;
storing the one or more initial values for each variable of the set of variables in a set of samples;
iteratively, until a termination criteria is met:
selecting at least a subset of samples from the set of samples;
generating a diversity Hamiltonian based on the at least a subset of samples from the set of samples;
combining the problem Hamiltonian with the diversity Hamiltonian to generate an updated problem Hamiltonian;
sampling one or more additional values for the set of variables from the updated problem Hamiltonian until an increase in a diversity of the sampled additional values is below a second threshold sampling diversity;
storing the one or more additional values for the set of variables in the set of samples; and
evaluating the termination criteria; and
upon meeting the termination criteria, returning the set of samples.

17. The method of claim 16, wherein updating the problem Hamiltonian comprises adding the diversity Hamiltonian weighted by a diversity parameter to the problem Hamiltonian.

18. The method of claim 16, wherein generating a diversity Hamiltonian comprises generating an anti-Hopfield model for the problem Hamiltonian based on the at least a subset of the first set of samples.

19. The method of claim 16, wherein sampling one or more values for the set of variables from the problem Hamiltonian comprises performing an optimization algorithm on the problem Hamiltonian, and wherein sampling one or more values for the set of variables from the updated problem Hamiltonian comprises performing the optimization algorithm on the updated problem Hamiltonian.

20. The method of claim 19, wherein:
performing the optimization algorithm comprises performing quantum annealing on a quantum processor;
generating a diversity Hamiltonian comprises generating an anti-Hopfield model for the problem Hamiltonian based on the at least a subset of the first set of samples;
each of the problem Hamiltonian, the diversity Hamiltonian, and the updated problem Hamiltonian define bias values for a plurality of qubits of the quantum processor and coupling values for a plurality of couplers of the quantum processor, the plurality of couplers communicatively coupling the plurality of qubits; and
generating the anti-Hopfield model for the problem Hamiltonian comprises flipping a sign of a coupling term of the problem Hamiltonian.
